(19) United States
(12) Patent Application Publication
(10) Pub. No.: US 2014/0004817 A1
(43) Pub. Date: Jan. 2, 2014

(54) CELL PHONE DETECTION AND ALERT INFORMATION SYSTEM

(71) Applicants: Andrew Horton, Sarasota, FL (US); Sebastian Mascaro, Championsgate, FL (US)

(72) Inventors: Andrew Horton, Sarasota, FL (US); Sebastian Mascaro, Championsgate, FL (US)

(21) Appl. No.: 13/929,817

(22) Filed: Jun. 28, 2013

Related U.S. Application Data
(60) Provisional application No. 61/666,321, filed on Jun. 29, 2012.

(51) Int. Cl. H04W 4/26

(52) U.S. Cl. CPC H04W 4/26
USPC 455/405

(57) ABSTRACT

The application discloses an information system and method of use for detecting and managing wireless communications in a controlled environment comprising an alert module configured to display alerts triggered by notifications from wireless sensors, where the wireless sensor notifications are normalized by the alert module prior to display based on the time of alerts and signal strength of neighboring sensors, an investigation module configured to filter and analyze alerts, the investigation module comprising a ticketing process configured to track alerts and a reporting module configured to analyze data captured by the information system based on calling patterns. The calling patterns include specific numbers dialed, calls regularly placed at a specific time or on a specific date, one number being dialed consistently before or after another number is dialed. The reporting module also displays connections between entities of interest.

### TECHNICAL FIELD

This application generally relates to a system and method for detecting unauthorized cell phones in controlled environments such as prisons.

### DESCRIPTION OF THE RELATED ART

There is a need to detect, control and monitor wireless communications in controlled environments such as prisons, military bases, or government organizations. With the reduced size, cell phones can be smuggled into prison facilities, or be otherwise made available to inmates, to communicate information with individuals outside the facility. Inmates may thus bypass the normal land line telephone control system commonly used to control communication into and out of a prison.

U.S. Pat. No. 5,615,261 to Grube et al. teaches a method and apparatus for detecting illicit radio frequency (RF) data transmissions. This is accomplished by employing an RF security monitor positioned within the transmission range of a wireless communication system. As a first RF node communicates data to a second RF node via an RF communication path, the RF security monitor monitors this communication to determine whether it is an illicit RF data communication. A major limitation of such systems is the difficulty in distinguishing between illicit and authorized transmissions resulting in many false alarms.

Another detection system in the prior art is taught in Patent Application US 2001/0036821 to Gainsboro et al. which describes a system comprising a radiotelephone interface and an apparatus for detecting and controlling wireless transmissions either by a caller from within the institution or by a caller from outside the institution. The system monitors wireless transmissions, tests signals for approval, and enables or prevents the transmissions via jamming or other means. Again, such systems are susceptible to false alarms as the identification of an unauthorized wireless transmission is accomplished through the detection of certain identifying signals which are commonly associated with such transmissions, or, alternatively, via voice recognition.

US Patent Application 2008/0043993 to Johnson teaches an apparatus and methodology for monitoring for the occurrence of use of unauthorized telecommunications equipment within a designated area. It also provides a capability for recording and storage of time, date and location information for detected events. Alerts are forwarded to a telephone system for notification to security personnel. One of the primary drawbacks of such systems is that they depend on the 24/7 availability of prison personnel to act on alerts as they are reported in order to be effective. Many agencies do not have the resources to support this level of operation. Even in cases where personnel are available to perform searches around the clock, the agency often prefers to conduct searches at times when inmates are routinely scheduled to be out of their cell or housing unit to avoid confrontation and facilitate a more rapid, unhindered search of the area.

There is therefore a need for a system capable of accurately locating the source of a wireless communication without having to monitor the actual transmission.

In addition to the dependency upon the availability of staff, typical cell phone detection systems are limited in the scope of what they offer the agency once a cell phone has been detected (beyond the resulting notification).

U.S. Pat. No. 8,099,080 to Rae et al. teaches a system and method to facilitate wireless communication in a controlled environment. Embodiments operate to recognize wireless communications, whether voice, text, video, or data, terminating within a controlled environment facility and control one or more aspects of the communication using a call processing platform or other communication control system. Embodiments of the disclosure provide improved investigatory tools for the controlled environment facility through controlling, monitoring, redirecting, and/or interrupting wireless communications. A major limitation of such system is that it is limited to a single facility.

There is therefore a need to provide a system to aggregate the data generated by cell phone sensors from multiple sites a single centralized point. This allows security staff the ability to view the operating conditions of the system on a global basis as well as drill down to the individual sensor level.

Most (if not all) cell phone detection systems provide real-time notifications of cell phone activity. The most basic of systems offer visual notifications via LED or other visual indicator integrated into the sensor. Some systems combine a visual indicator with an audible tone generated by a buzzer or similar component in the sensor.

These notifications are made available only to personnel who are within the line of sight or within earshot of the sensor when it detects cell phone activity. As such, the range of both the visual and audible elements of the alert is sometimes extended through the deployment of external beacon lights and sirens.

Of course, these localized notifications also alert nearby inmates that cell phone activity has been detected, prompting them to turn off and hide the offending contraband cell phone(s) before prison staff are able to investigate the notification from the sensor.

In more sophisticated systems, notifications can be sent electronically to a computer that is directly connected, or otherwise networked to the sensor(s). Notifications generated in this manner usually occur outside of the awareness of the inmate, increasing the likelihood that an immediate search of the area monitored by the sensor will result in a cell phone being found in the open, possibly in the possession of an inmate.

Some systems support the real-time monitoring of multiple sensors and provide notification of detections through a graphical user interface. This functionality provides monitoring and investigation staff members with inputs that enable them to prioritize the specific location where they concentrate their search and recovery efforts which is a valuable proposition, but it falls short of providing an agency with a complete cell phone detection solution.

One of the primary drawbacks of this type of system is that it depends on the 24/7 availability of prison personnel to act on alerts as they are reported in order to be effective. Many agencies do not have the resources to support this level of operation.

Even in cases where personnel are available to perform searches around the clock, the agency often prefers to conduct searches at times when inmates are routinely scheduled to be out of their cell or housing unit to avoid confrontation and facilitate a more rapid, unhindered search of the area.

In addition to the dependency upon the availability of staff, typical cell phone detection systems are limited in the scope of what they offer the agency once a cell phone has been detected (beyond the resulting notification). They lack the ability to:
Aggregate notifications from multiple site into a single, centralized location
Analyze historical data to reveal patterns and trends of cell phone activity
Compare and contrast detections by site, building, housing, floor, and sensor
Compare and contrast detections over specified time periods
Initiate, track and report the results of a search for contraband cell phones
Compare confiscations by site, building, housing, floor, and sensor
Compare confiscations over specified time periods
Contrast confiscations vs. searches where no phone was found
Contrast confiscations that resulted in a possession, vs. those that didn't
Integrate barcode or other tagging method to track cell phones once they have been confiscated
Integrate data collected from confiscated contraband cell phones for investigative purposes
Analyze data and its relationship to elements of interest

There is therefore a need for a system able to track all events that take place from the time of a notification, through to the analysis of data collected from confiscated cell phones.

Furthermore, there is a need for a system capable of providing stake holders with the ability to collect, correlate and analyze data from multiple sources including inmate telephone systems.

There is also a need for an information system capable of providing agencies with an integrated suite of analytical and investigative tools that enable the user to query historical data retrieved from multiple sources to discover trends and patterns that would otherwise not be visible.

### SUMMARY OF THE DISCLOSURE

The information system of the present disclosure is a data-centric platform for the detection and management of wireless communications in a controlled environment that collects, formats and stores data from multiple sources so that the data aggregated can be accessed and analyzed to increase security for the prison service, law enforcement and the general public. The system platform provides unique information management and reporting services on communication activities between inmate populations and the outside world. It allows users to analyze patterns in the detection data and their relationship to various elements of interest such as false alarms.

In order to generate the breadth of analysis and reporting required for effective fraud prevention, the system has to interface and integrate with numerous disparate systems such as Inmate Telephone Systems (ITS), wireless device interrogation software and other applications and systems. As a cell phone detection system, it must first and foremost aggregate the cell phone detection alerts from multiple housing units in different buildings that collectively make up one or more sites assigned to an account.

One aspect of the present disclosure is the ability to aggregate notifications from multiple sites into a single, centralized location.

In an embodiment of the system, the data is aggregated centrally, offering authorized users a view of their account that spans multiple facilities. As such, it is possible to compare and contrast not only cell phone activity, but also the effectiveness of campaigns to confiscate cell phones across the physical locations that comprise the account.

Another aspect of the present disclosure is the ability to remove redundant alarms by correlating information from neighboring sensors based on time, signal frequency and signal strength.

In certain environments, a single cell phone activity may generate a detection at multiple sensors. If no safeguards are in place to protect against it, a single cell phone activity event may register as multiple detections within the cell phone detection system. This condition would generate an artificially high number of detections recorded within the system. Further, it could result in the needless dispatching of staff to search for cell phones that simply don't exist. In an embodiment of the system, the sensor data is processed at a central level prior to making it available for presentation and analysis. To accomplish this, the system checks the time an alert is initiated, along with the frequency band and the signal strength against neighboring sensors. The results are normalized and cleansed based upon a proprietary algorithm.

Another aspect of the present disclosure is the ability to analyze historical data to reveal patterns and trends of cell phone activity.

A further aspect of the present disclosure is the ability to compare and contrast detections by site, building, housing, floor, and sensor.

Another further aspect of the present disclosure is the ability to compare and contrast detections over specified time periods.

Still another aspect of the present disclosure is the ability to initiate, track and report the results of a search for contraband cell phones.

Another aspect of the present disclosure is the ability to compare confiscations by site, building, housing, floor, and sensor.

A further aspect of the present disclosure is the ability to compare confiscations over specified time periods.

Still another aspect of the present disclosure is the ability to contrast confiscations vs. searches where no phone was found

Still another aspect of the present disclosure is the ability to reduce false positive alarms by contrasting confiscations that resulted in a possession, vs. those that didn't

Still another aspect of the present disclosure is the ability to integrate barcode or other tagging method to track cell phones once they have been confiscated

Still another aspect of the present disclosure is the ability to Integrate data collected from confiscated contraband cell phones for investigative purposes

### BRIEF DESCRIPTION OF THE DRAWINGS

The disclosure may best be understood by reference to the following description taken in connection with the accompanying drawings in which:

FIG. 1 is a schematic description of an embodiment of the sensor hierarchy.

FIG. 2 is a functional description of an embodiment of the system module.

FIG. 3 is an illustration of the display of an embodiment of the alert module.

FIG. 4 is an illustration of the display of an embodiment of the alarm module.

FIG. 5 is an illustration of the display of an embodiment the new ticket function

FIG. 6 is an illustration of the display of an embodiment the active ticket function

FIG. 7 is an illustration of the display of an embodiment of the completed ticket function.

FIG. 8 is an illustration of the display of an embodiment of the summary function in the investigation module.

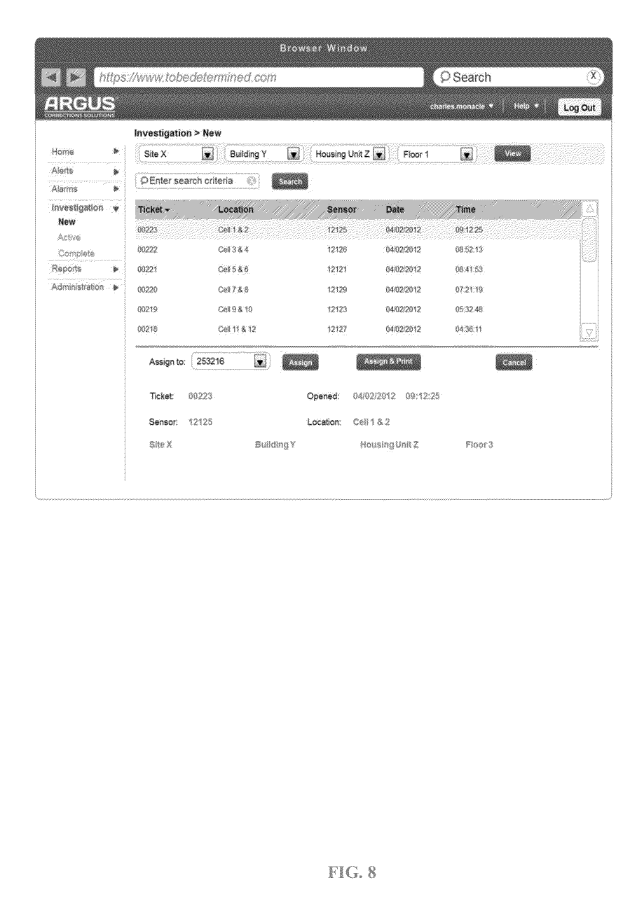

FIG. 9 is an illustration of the display of an embodiment of the active investigation function in the investigation module.

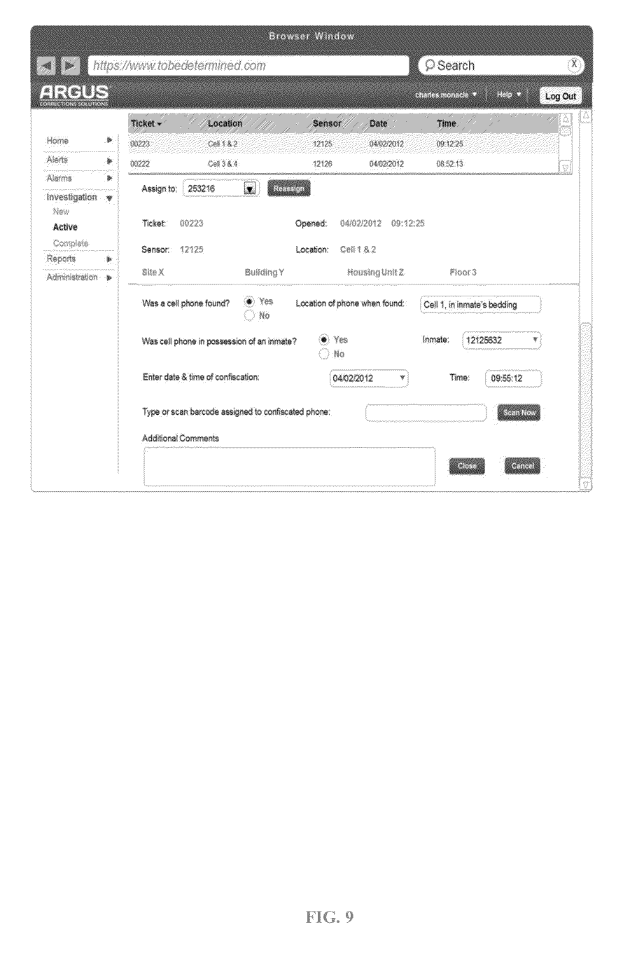

FIG. 10 is an illustration of the display of an embodiment the completed investigation function in the investigation module.

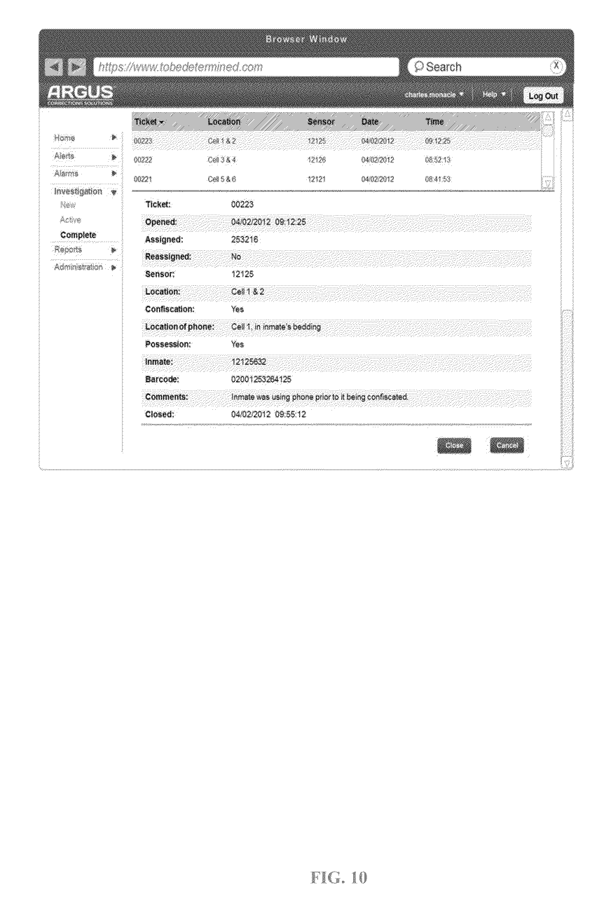

FIG. 11 is an illustration of the display of an embodiment of the filter summary function in the reporting module.

FIG. 12 is an illustration of the display of an embodiment of the filter by sensor function in the reporting module

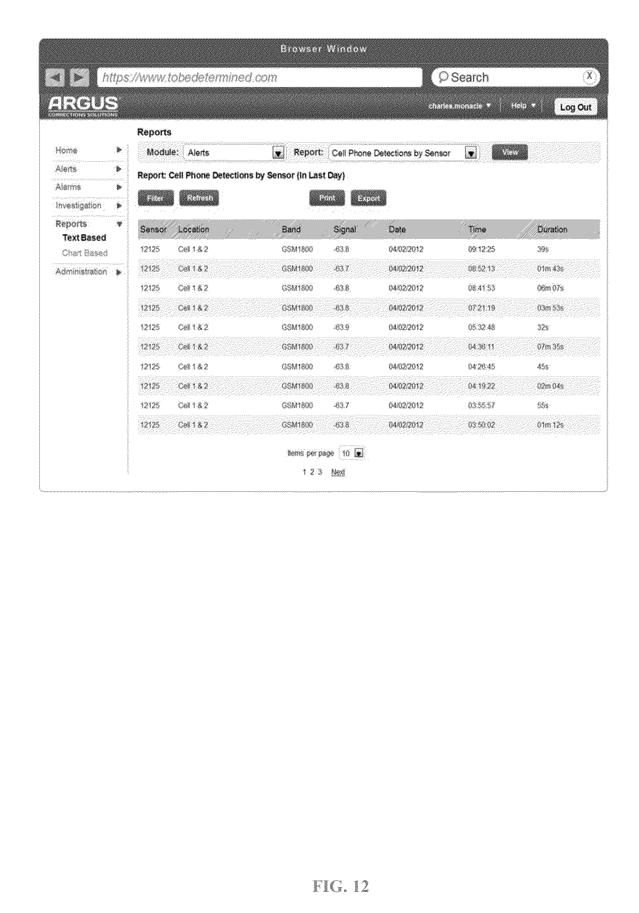

FIG. 13 is an illustration of the display of an embodiment of the filter by duration function in the reporting module.

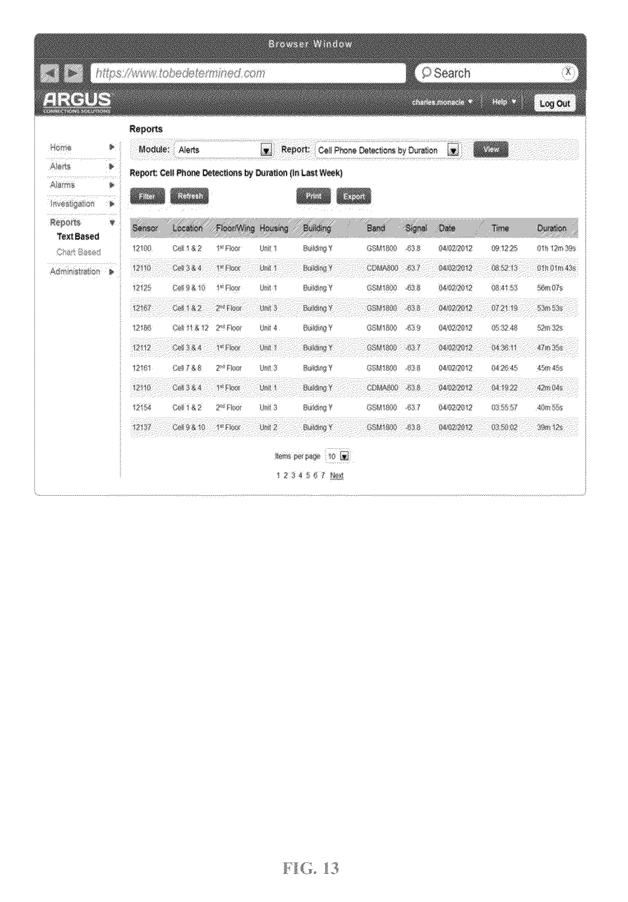

FIG. 14 is an illustration of the display of an embodiment of the filter by frequency function in the reporting module.

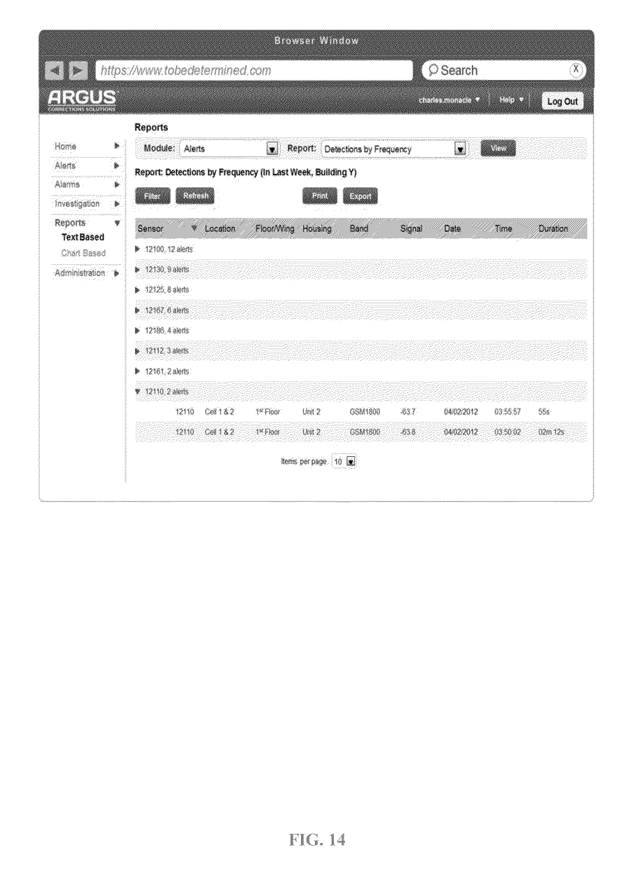

FIG. 15 is an illustration of the display of an embodiment of the filter by inactivity function in the reporting module

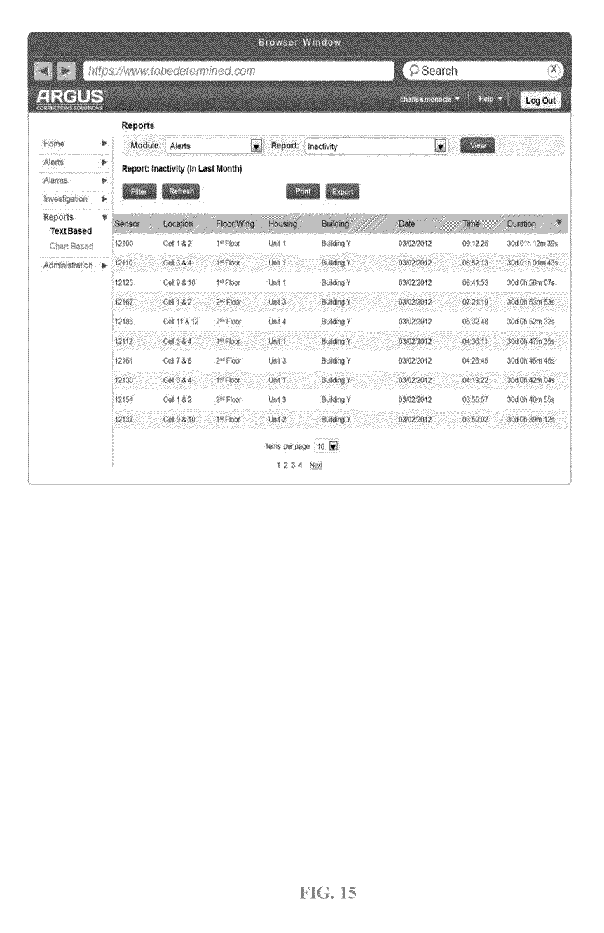

FIG. 16 is an illustration of the display of an embodiment of the filter by account function in the reporting module.

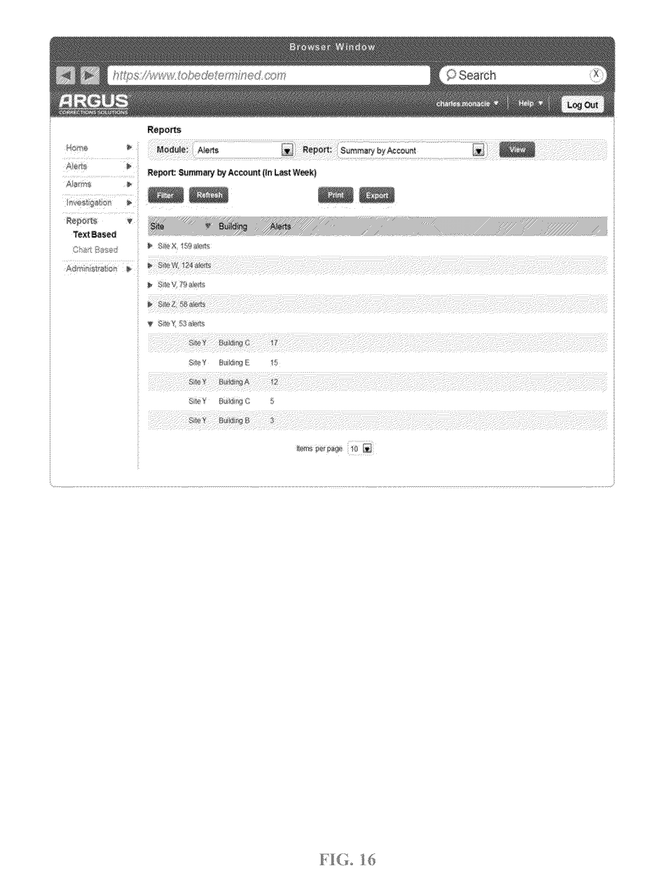

FIG. 17 is an illustration of the display of an embodiment of the summary function of the Account management module

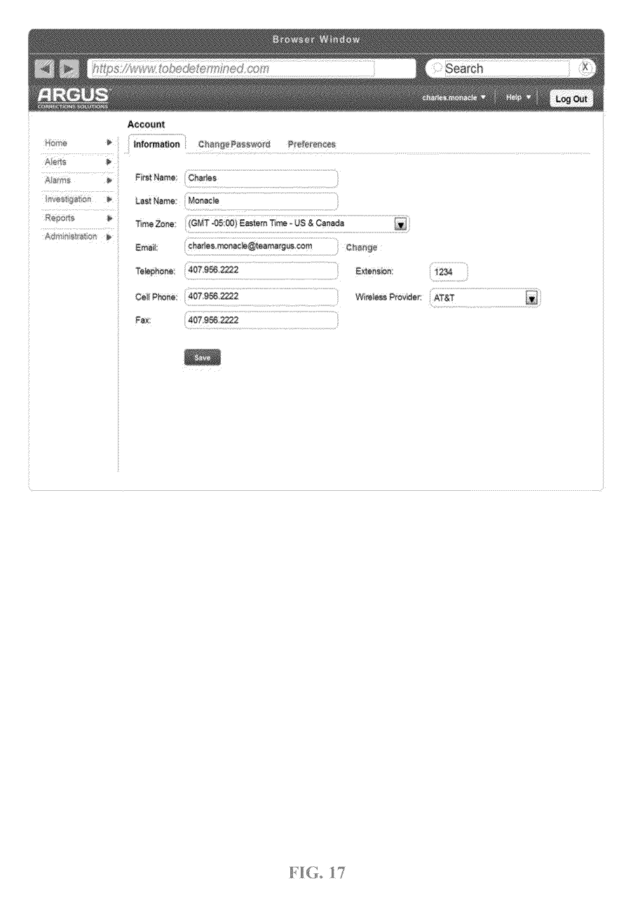

FIG. 18 is an illustration of the display of an embodiment of the preferences function of the account management module.

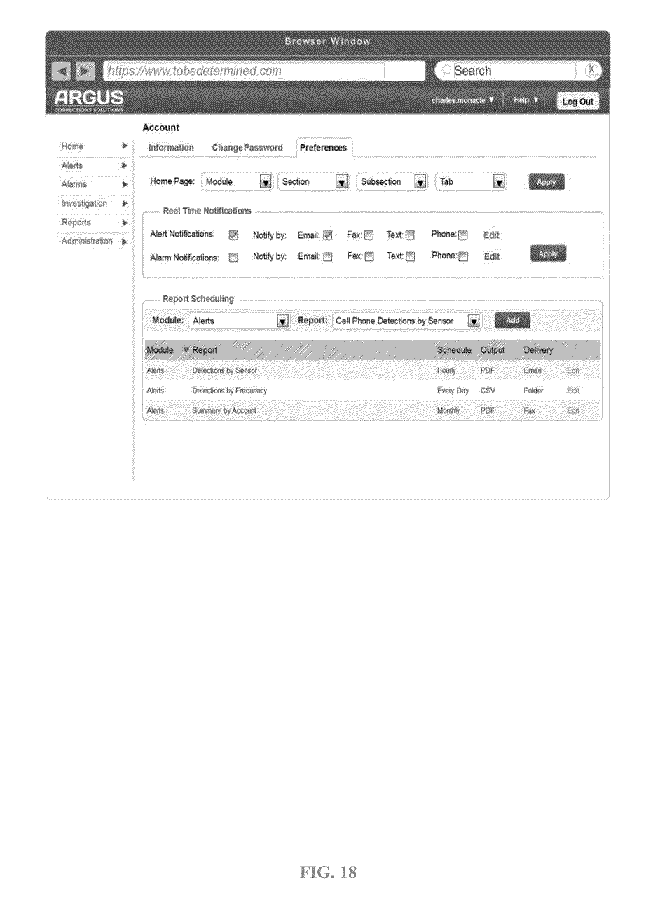

FIG. 19 is an illustration of the display of an embodiment of the access control function of the account management module.

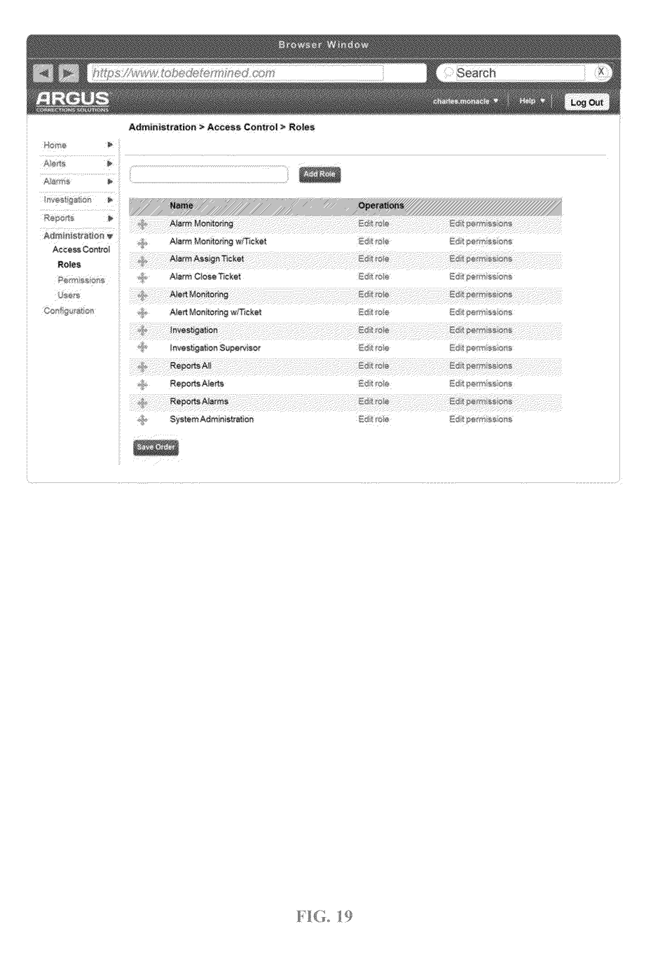

FIG. 20 is an illustration of the display of an embodiment of the permission control function of the administration module

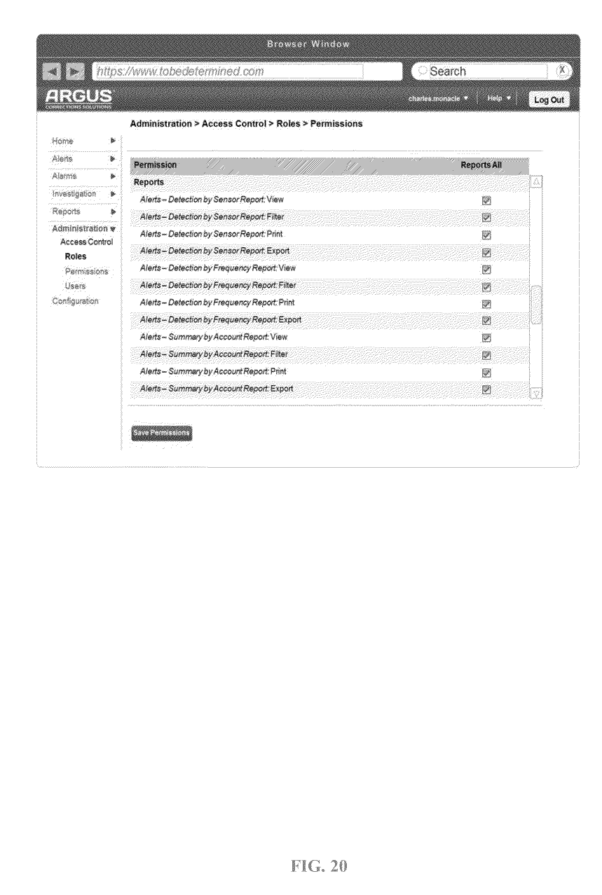

FIG. 21 is an illustration of the display of an embodiment of the user access control function of the administration module

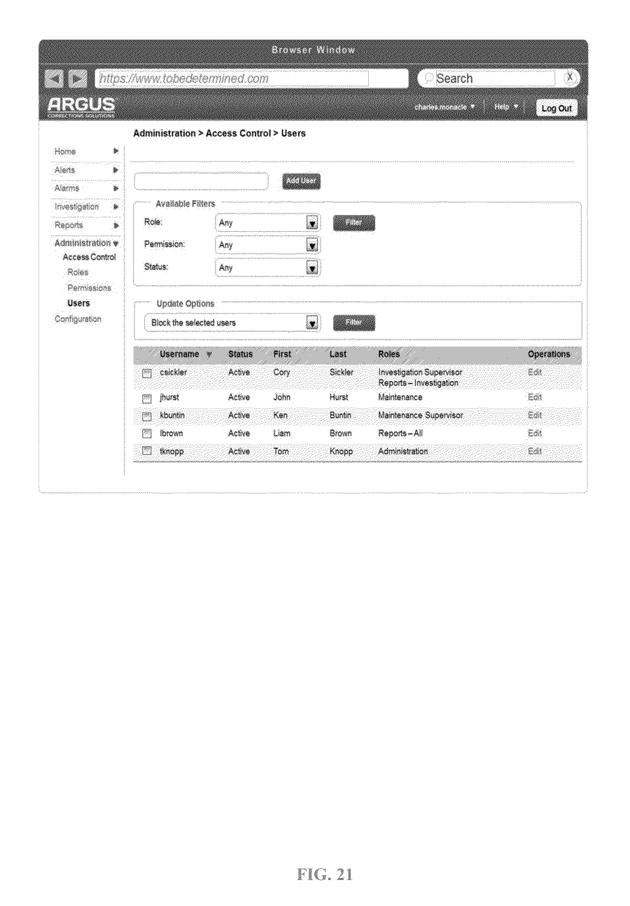

FIG. 22 is an illustration of an embodiment of the display from the output of the source localization algorithm.

FIG. 23 is an illustration of an embodiment of the heat map display function of the reporting module.

FIG. 24 is an illustration of an embodiment of the pattern analysis function of the reporting module.

### DETAILED DESCRIPTION

### Sensor Hierarchy

To facilitate both high level and granular interpretation of the data collected from the sensors, the cell phone detection and management system includes a hierarchy relative to the physical location of each sensor. Such a hierarchy includes:
Account (Agency)
Facility
Building
Housing
Floor/Wing
Cell
Offender

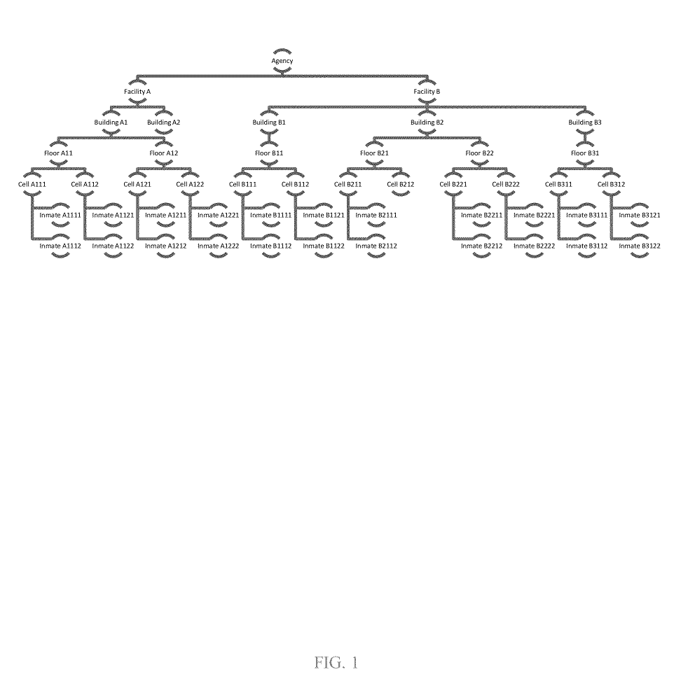

FIG. 1 shows the sensor hierarchy in an embodiment of the system. The centralized platform will interpret the data generated by a sensor and adjacent sensors. In the case of an alert that is (simultaneously) reported by multiple sensors it will attempt to localize the source of the cell phone signal based upon the signal strength reported by the sensors that originate the alert and the location of the sensors within the hierarchy of physical locations. It is also the hierarchical structure that enables administrators to analyze and compare detections by facility, building, floor or wing and correlate results with confiscations for the same locations.

### System Operation

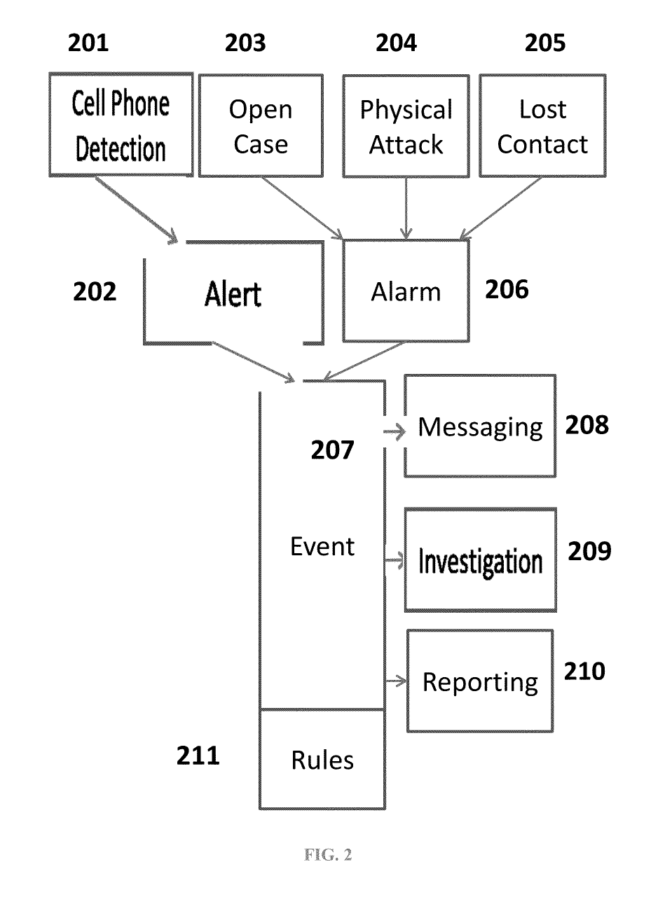

FIG. 2 illustrates an embodiment of the operation of the information system. A cell phone detected by one or more sensors 201 triggers the alert module 202. Alternatively, opening of a sensor 203, tampering with a sensor 204 or loss of a sensor signal 205 will trigger the alarm module 206. The alert module 202 and the alarm module 206 will automatically generate an event 207. Based on pre-defined rules 211, the messaging module 208, the investigation module 209 or the reporting module 210 will be in turn activated.

### Alert Module

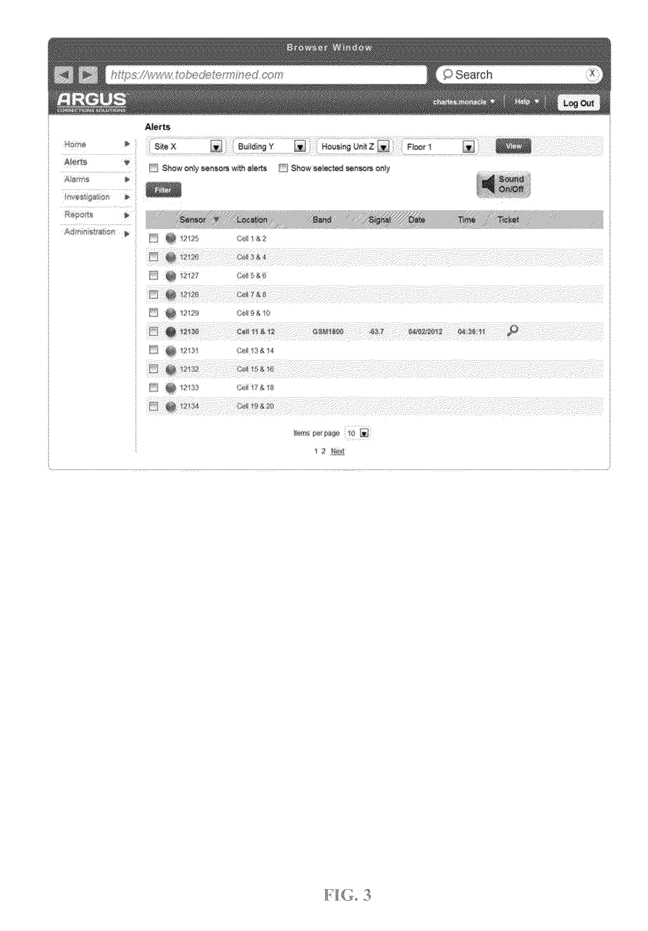

FIG. 3 is an illustration of the display of an embodiment of the alert module. The availability of real time notifications of cell phone activity is a core functionality available in the current platform. Through the alert module authorized users can view the real time alerts triggered by sensors that they have permissions to access. This information can be used to generate tickets that initiate searches from contraband cell phones in real time.

### Alarm Module

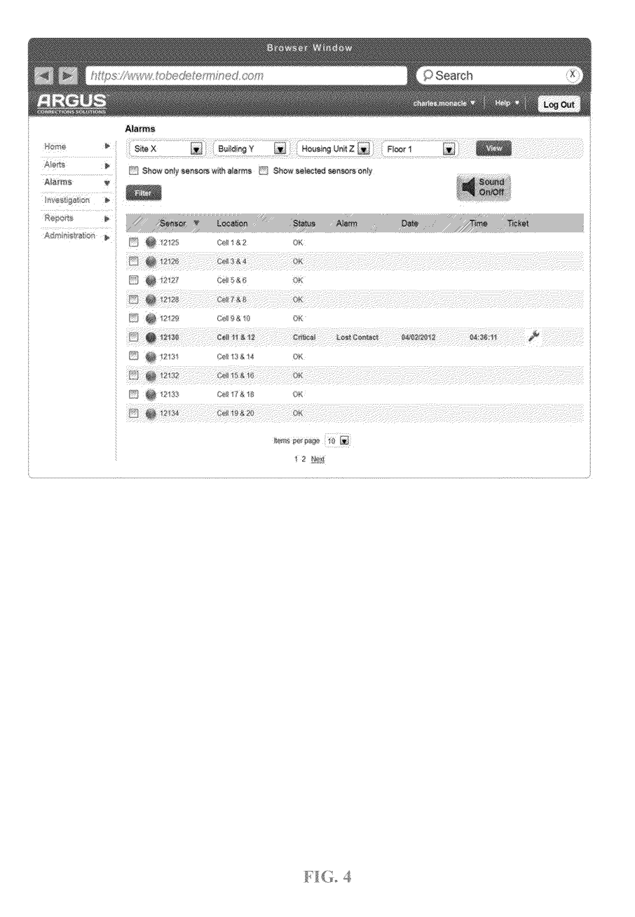

FIG. 4 is an illustration of the display of an embodiment of the alarm module. An alarm is triggered when a condition exists that affects the operation of the sensor. A specific event triggers an alarm condition and the sensor signals the platform of the event. The exception to this rule is the lost contact alarm which is alerted after a specified period of time has elapsed since the last contact with the sensor.

Alarms can be triggered for the following reasons:
Case open
Lost contact
Physical attack

### Investigation Module

The investigation module includes a ticketing system that can be utilized to initiate, track and report the outcome of searches for contraband cell phones. The ticketing system is designed to require the minimum of user input while at the same time capturing all of the data relevant to contraband cell phone confiscations. Wherever possible, the system automatically inputs data into the ticket based upon established known configurations.

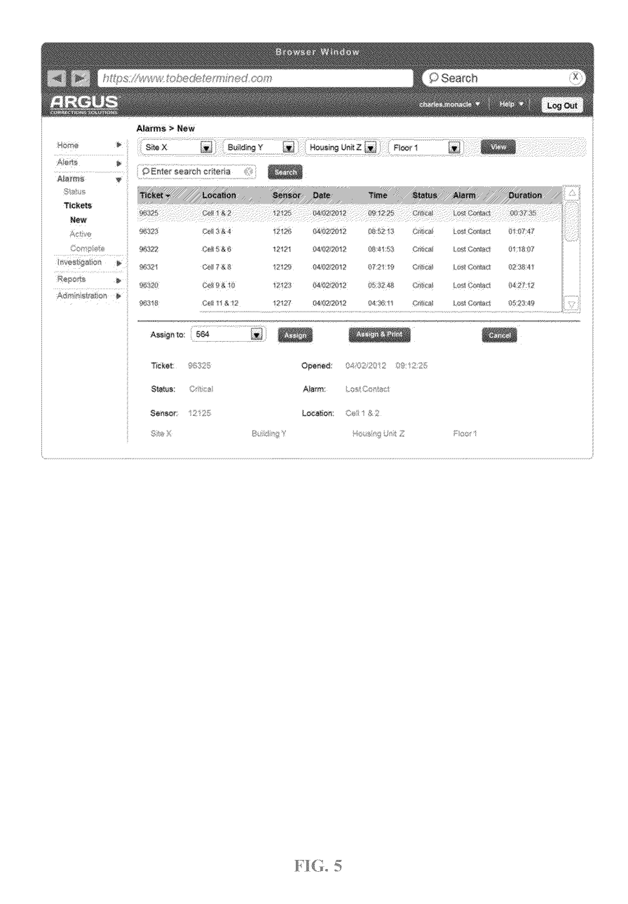

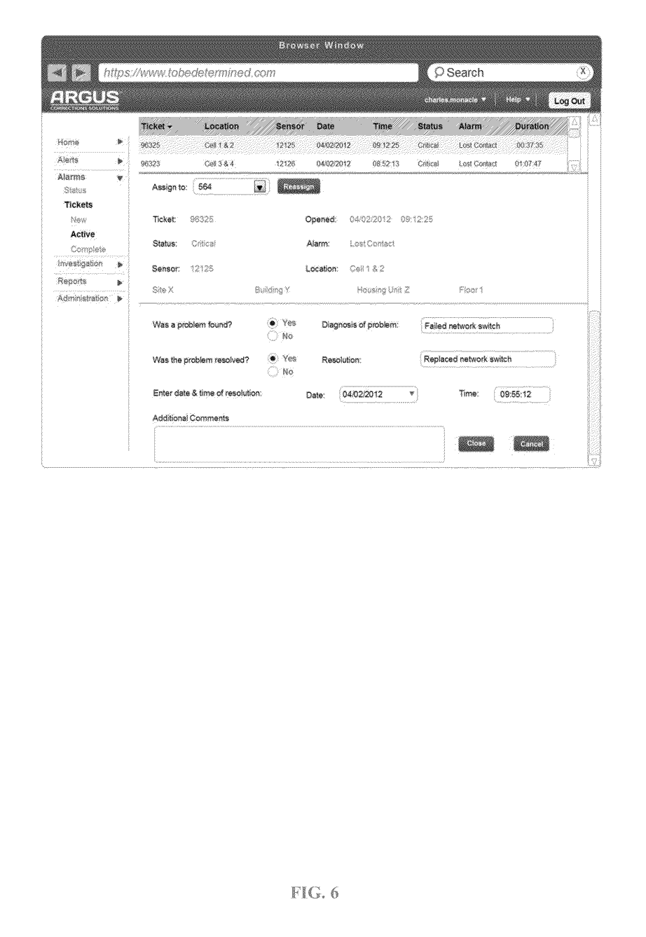

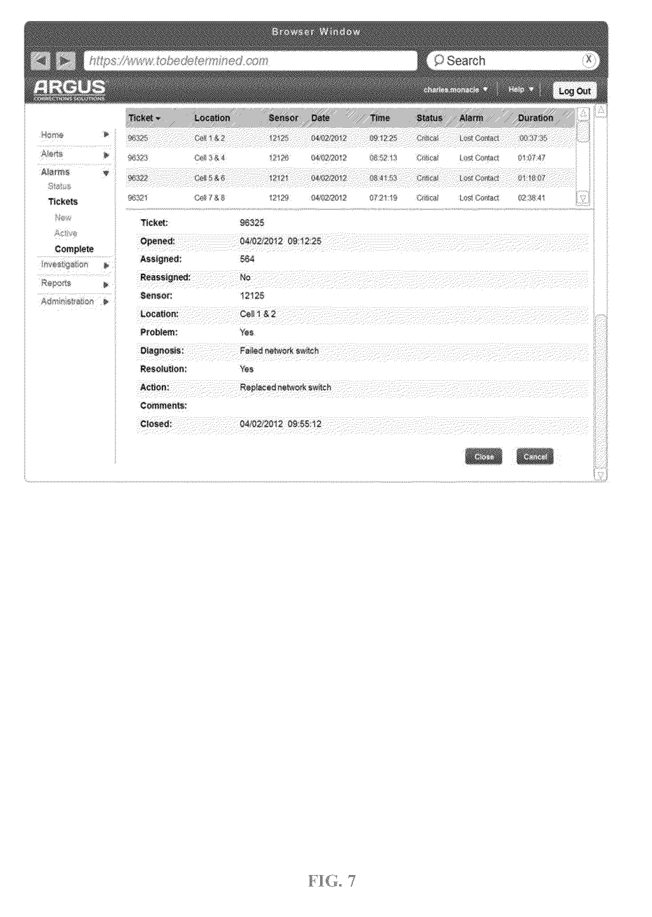

There are three stages in the ticketing process:
1. The New stage that occurs at the moment of opening a ticket illustrated in FIG. 5
2. The Active stage once a staff member has been assigned to a new ticket illustrated in FIG. 6
3. The Complete stage illustrated in FIG. 7 that occurs once a staff member has closed the ticket after inputting the following:
   a. Whether or not a cell phone was found during the search, and if yes
   b. The location of the phone when found
   c. Whether or not the phone was found in the possession of an inmate
   d. The inmate that possessed the phone
   e. The date and time of the confiscation
   f. The barcode or other tracking method attached to the confiscated phone
   g. Any additional comments pertinent to the confiscation

As the system requires input from a user at each stage of the ticketing process, it provides the agency with the ability to track the duration of each stage. Further, the centralized nature of the system facilitates the contrast and comparison of these timelines between housing units, buildings and sites that comprise the account. Therefore, the agency has a means of evaluating the relative performance of one or more users and as such, they can establish benchmarks and identify areas that fall short of the benchmarks and intervene with a corrective modality such as education and training to elevate performance to the benchmarked levels. The same approach can be made to address underperformance in the areas of searches vs. confiscations and confiscations vs. possessions.

### Reporting Module

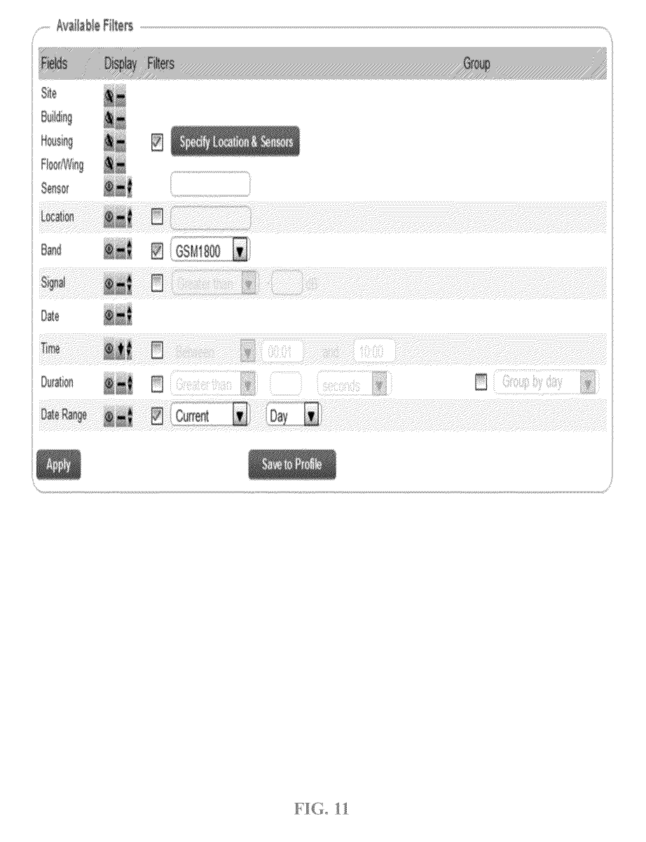

FIG. 11, 12, 13, 14, 16, 17 are illustrations of the display of an embodiment the reporting module. If resources do not permit real-time operation, or if for some other reason, the client prefers to search for contraband cell phones based upon patterns and trends revealed through the analysis of historical data he may do so by using the tools provided in the reporting module.

The opportunity to analyze historical data generated by sensors and collected, normalized and stored by the platform provides prison staff with the ability to confidently make actionable decisions (such as which cell to “toss,” or what inmate to search), that have the highest possible likelihood of yielding contraband cell phone(s).

Through the reporting module, authorized users gain access to advanced tools that provide them with the ability to access, filter, and sort data so that reports are presented in precisely the manner in which is most suitable for their role. As a result, users have the tools they need to drill down into the data related to alerts and expose and interpret trends and patterns of activity. These patterns and the resulting tickets generated to initiate a search for a contraband cell phone are based on consistent and reliable data, enabling the agency to initiate searches on a prioritized basis. The ability to initiate searches based on reliable patterns of activity and the resulting ability to prioritize searches means that agency staff can enjoy a predictable increase in productivity resulting in a higher ratio of cell phone confiscations and possessions per search.

### Normalization of Cell Phone Detection

One of the most overlooked dimensions associated with detections is the quality of the information sourced from the sensors. This is particularly true in environments where multiple sensors are networked or otherwise connected together to protect a specific area such as a pod, or other housing unit. In environments such as these, a single cell phone activity may generate a detection at multiple sensors. If no safeguards are in place to protect against it, a single cell phone activity event may register as multiple detections within the cell phone detection system. This condition would obviously generate an artificially high number of detections recorded within the system. Further, it could result in the needless dispatching of staff to search for cell phones that simply don't exist.

The information system against this situation by normalizing and cleansing data contained within the sensor notifications at a central level prior to making it available for presentation and analysis. To accomplish this, the system checks the time an alert is initiated, along with the frequency band and the signal strength against neighboring sensors. As the design of the sensor mesh necessitates overlap within the effective range of one or more sensors within the mesh, the system includes a normalization method of determining whether a notification reported by multiple sensors originates from a single RF source (wireless device) or multiple sources. By doing so, the system is able to dramatically reduce the number of false positive detections reported to authorized users in real time and provides a more statistically accurate representation of the historical activity of contraband wireless devices within the agency overtime, via reporting services. The normalization process operates within a middleware application that receives, analyzes and calculates the data present in the messages sent from the sensors to the host server. Normalization calculations are based upon the following inputs:
Physical location of the sensor
The timestamp of the notification
The frequency and band of the RF source
The direction of the RF source
The signal strength of the RF source using received signal strength indicator (RSSI)

The contents of the message received from one sensor are compared to detection messages received from other sensors within the mesh. Notifications that contain data that matches within established benchmarks and thresholds are normalized as originating from a single source. Notifications that do not meet these criteria are not normalized as part of the initial process and are either processed again against input from other sensors in the mesh or recorded as a separate detection.

### Localization of Source of Contraband Device

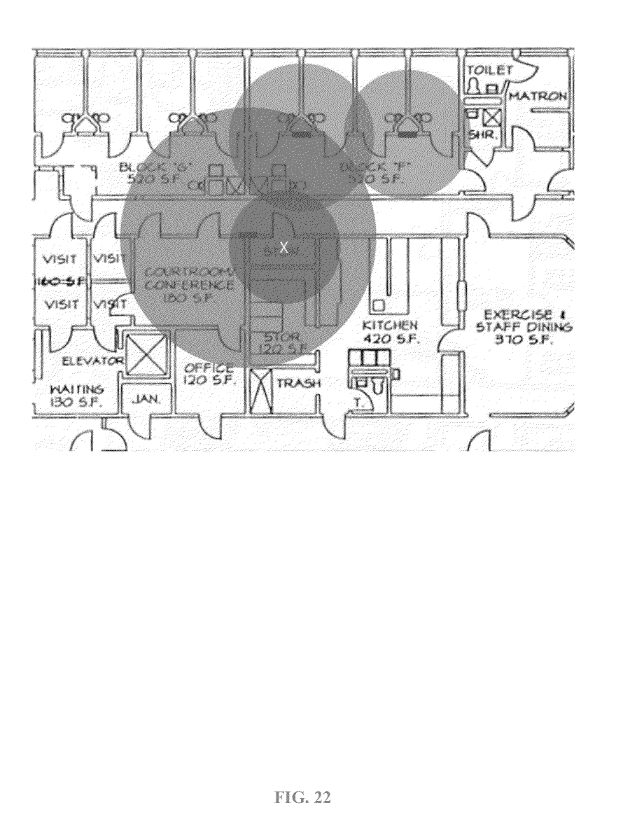

In addition to the normalization process, a localization process is initiated upon detection reported by multiple sensors. The localization application processes data related to the surrounding environment that is added at the time of deployment. This data includes references to construction materials used in the immediate and surrounding areas, the type of cells and the materials used for the opening of the cell (metal doors, metal bars, etc.) and the height of the sensor installation. In addition to this data, the same inputs as those mentioned in the normalization algorithm, are processed and the localization algorithm outputs a likely location of the source of the contraband wireless device. FIG. 22 illustrates an embodiment of the visual display of the result from the localization process. The estimated location is displayed as a marker within the user interface in an “X marks the spot,” manner. This marker is an additional visual indicator that is overlaid on the standard real time user interface.

The inclusion of the localization output in the real-time display of the status of the system assists authorized users to determine the location of a contraband wireless device in one specific physical location. When a search is initiated to confiscate the contraband device, the ability to act with a high level of certainty that the contraband device is (most likely) in the room/cell being searched increases the likelihood of a successful search and confiscation. In addition to the obvious advantages of localization in the effort to confiscate contraband wireless devised, the system will indicate the movement of a wireless device, contraband or otherwise, perhaps indicating that the device belongs to a prison, or other authorized staff member.

### Pinpointing Contraband Devices Using Heat Map Technology

In environments where resources do not permit the availability of personnel to search for contraband wireless devices in real-time, prison personnel must have an effective system for determining when and where to search for contraband devices. Many searches are initiated when the prison staff is notified that an inmate is in possession of a contraband device. Additional searches are conducted based upon the input from prison personnel who have witnessed an inmate in possession of a contraband device. While this method does result in the confiscation of some contraband devices, it is obviously limited in that a reliable input from a witness is needed to initiate a search.

To combat this limitation, prison personnel may conduct additional searches in a uniform “sweep” pattern where each section of the prison is searched over time. This approach yields poor results due to the predictable nature of the sweep and the ability of inmates to communicate the start of a campaign to other inmates, prompting them to go to great lengths to hide contraband devices.

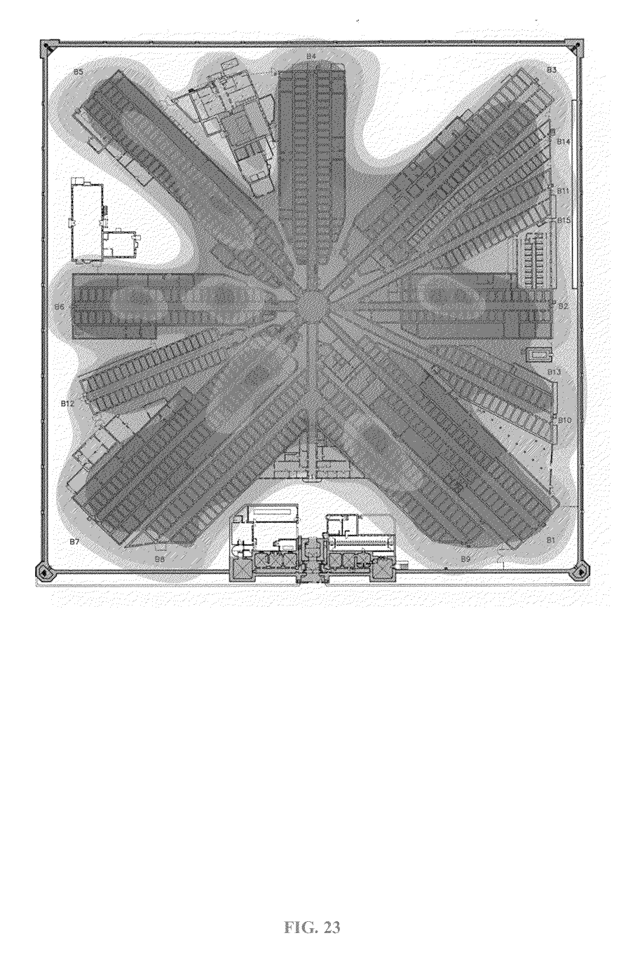

To increase the likelihood that contraband devices will be confiscated during a search, the system clearly depicts the physical locations where the highest level of cell phone activity has been recorded over time. This activity is presented to authorized users in the form of a heat map. FIG. 23 illustrates an embodiment of the display of the heat map function. The physical location with the highest activity is shown in red, indicating the “hottest” area for contraband usage. Areas with lessening levels of activity are displayed in increasingly “cooler” colors.

Through the use of the heat map reporting, the agency is able to prioritize the search efforts of personnel in the areas of greatest activity. This approach eliminates the possibility that an area with no contraband devices is swept and dramatically increases the likelihood that contraband devices will be found and confiscated during the search.

The ability to pinpoint and prioritize the search and confiscation effort spans across prison buildings and even prison sites means that the agency can concentrate their efforts only in the locations that pose the greatest threat levels.

### Analysis of Historical Data to Reveal Patterns and Trends

The information system of the current disclosure is a data-centric platform that collects, formats and stores data from multiple sources so that the data aggregated can be accessed and analyzed to increase security for the prison service, law enforcement and the general public. The tools available to the client, collectively known as the Intelligence Suite provide an insight into never before seen relationships and activities between inmate populations and the outside world.

Aggregating Notifications from Multiple Locations into a Single, Centralized Platform

In order to provide breadth of analysis and reporting, the information system will interface and integrate with numerous disparate systems such as Inmate Telephone Systems (ITS), wireless device interrogation software and other applications and systems. Of course, as a cell phone detection system, it must first and foremost aggregate the cell phone detection alerts from multiple housing units in different buildings that collectively make up one or more sites assigned to an account. By aggregating the data centrally, the information system offers authorized users a view of their account that spans multiple facilities. As such, it is possible to compare and contrast not only cell phone activity, but also the effectiveness of campaigns to confiscate cell phones across the physical locations that comprise the account.

Through the alert module users can see the real time alerts generated by sensors that they have permissions to view. This information can be used to generate tickets that initiate searches from contraband cell phones in real time, if that is the strategy of choice for the client.

If resources do not permit this level of operation, or if for some other reason, the agency prefers to search for contraband cell phones based upon patterns and trends revealed through the analysis of historical data; they may do so by using the tools provided in the reporting module.

Through the reporting module, authorized users gain access to advanced tools that provide them with the ability to access, filter, and sort data so that reports are presented in precisely the manner in which is most suitable for their role.

As a result, users have the tools they need to drill down into the data related to alerts and expose and interpret trends and patterns of activity. These patterns and the resulting tickets generated to initiate a search for a contraband cell phone are based on consistent and reliable data, enabling the agency to initiate searches on a prioritized basis.

The ability to initiate searches based on reliable patterns of activity and the resulting ability to prioritize searches means that agency staff can enjoy a predictable increase productivity resulting in a higher ratio of cell phone confiscations and possessions per search.

Integration of Data Collected from Confiscated Cell Phones

When agency personnel confiscate a cell phone, it is tagged, and the tag is recorded in the information system as a part of the process of closing the ticket. Confiscated phones are processed by investigation staff, either at the facility, at a centralized point within the agency or at a third party such as Guarded Exchange. Processing involves the electronic interrogation of the cell phone via third party software.

The information system interfaces with multiple third party software applications that retrieve data from cell phones. In cases where the information system is directly interfaced to the third party software, data is extracted from the phone and structured and stored in the central repository.

Data retrieved and made available includes, but is not limited to:
Basic phone information and SIM-card data*
Multimedia Messages with attachments
Contacts list (including mobile, wireline, fax numbers, postal addresses, contact photos and other contact information)
E-mail Messages with attachments
Missed/Outgoing/Incoming calls
Photos and gallery images
Caller Groups information
Video clips and films
Organizer content (calendar meetings, appointments, memos, call reminders, anniversaries and birthdays, to-do tasks)
Voice records and audio clips
Text notes
All files from phone memory as well as from flash card, including installed applications and their data
SMS Messages (messages, log, folders, deleted messages with some restrictions)
Web browser cache and bookmarks
Lifeblog activity: all main events with geographical coordinates

The Subscriber Identity Module (SIM) card contains network specific information used to authenticate and identify subscribers on the network. These include, but are not limited to the card's unique serial number (ICCID), international mobile subscriber identity (IMSI), security authentication and ciphering information, temporary information related to the local network, a list of the services the user has access to and two passwords: a personal identification number (PIN) for ordinary use and a personal unblocking code (PUK) for PIN unlocking with the intervention of the wireless carrier.

In addition, the SIM card may contain additional information such as phone contacts, SMS messages and last number dialed. Contacts are stored in name and number pairs. Contacts that include more than one number are either not stored on the SIM or the OS of the phone stores multiple name and number pairs for the contact.

The information system provides corrections and law enforcement agencies with new tools that facilitate faster, better and more effective ways of analysing and understanding data generated by the cell phone detection system in combination with the data retrieved from contraband cell phones and the authorized Inmate Telephone System (ITS). In the context of intelligence and investigation, the ability to access, correlate and analyse data from these three sources give clients a significant advantage over analysing a single source alone.

### Relationship Between Data and Targets of Interest

As a data-centric application, the information system automatically exposes new patterns and trends by perpetually accessing, analyzing and correlating information from multiple sources as data is added to the information system repository.

The objective of an investigation is to identify and connect a series of targets to generate a “big picture” that reveals criminal or other behavior(s) of interest. The targets represent objects or entities of interest, such as inmates, members of the public, or telephones.

Of course, in order to reveal the big picture, the targets must be connected in a specific order and sequence for the picture to be relevant. The process of connecting the targets reveals more and more of a pattern that might otherwise be hidden.

Unlike traditional approaches that were focused on the generation of standardized reporting with fixed output, based upon static queries, the information system provides the tools to uncover patterns and relationships in the stored data. Advanced analysis and correlation tools ensure that each pattern can be broken down into its network structures, featuring temporal sequences and geo/spatial relationships. Such patterns can then be interpreted to identify, quantify and protect against security breaches and/or other criminal activity.

Analysis begins with the pre-selection of an entity such as an inmate, a telephone call, telephone number, confiscated cell phone, victim, accomplice, street address, etc. Once selected, the entity of interest becomes the center or focus of the analysis. The goal of the analysis is to expand the known network and uncover additional leads and clues where the investigator would review all aspects of the subject to determine other people who are related to him through call records, or any other available source to reveal associations or connections that might expose security violations or criminal activities.

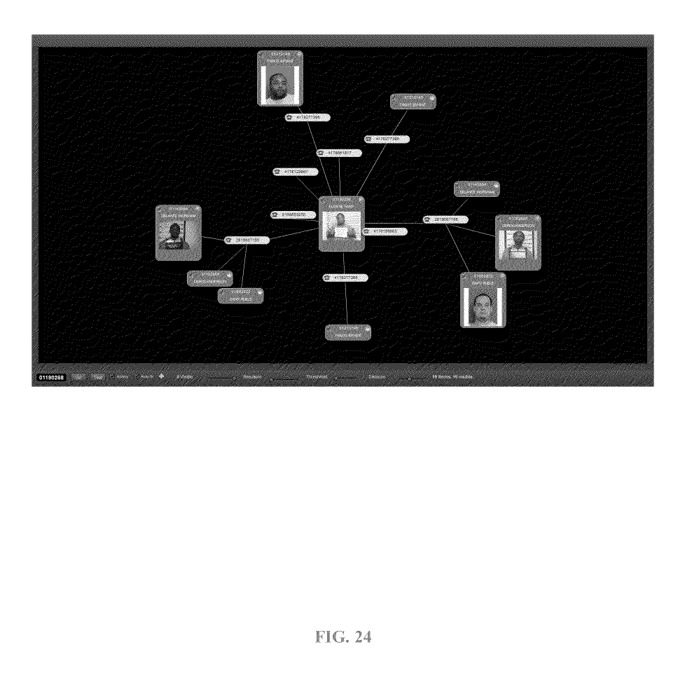

As this process advances, additional targets are connected, revealing a more complete and larger picture. Any new entities added to the picture may in turn become a source for a subsequent inquiry. Network diagrams are used to represent the connections between entities and any resulting patterns or trends. FIG. 24 is an illustration of such a network diagram.

### Analysis of Temporal Data

Temporal data, for example, Call Detail Records (CDR) is used to provide input that establishes a pattern of interaction between entities. All calls and even unsuccessful call attempts have a time/date & origination/termination component to them. Individually, a single call may appear to be of little significance. However, when all transactions involving the originating or terminating telephone number involved in a call are collectively displayed, the investigator can infer behavior based upon the calling patterns.

Potential patterns to be analyzed include absolute temporal references such as specific numbers dialed, or calls regularly placed at a specific time and/or on a specific date. Additionally, the investigator may research sequential patterns, such as one number being dialed consistently before or after another number (assigned to a person of interest) is dialed. This approach exposes additional people of interest, who become additional dots to be connected in the big picture. The goal of this type of investigation is to add and connect as many additional subjects/targets to the big picture and to focus investigative efforts on the best qualified target(s). This process can continue indefinitely, assuming the ongoing availability of data sources to query. Each time a new entity appears in the display, its relationship (connections) to prior subjects is queried and represented to the investigator. Cross referencing data sources makes it possible to expose broader, more complex criminal patterns.

What is claimed is:

1. An information system for detecting and managing wireless communications in a controlled environment comprising:
(a) an alert module configured to display alerts triggered by notifications from wireless sensors, wherein the wireless sensor notifications are normalized by the alert module prior to display based on the time of alerts and signal strength of neighboring sensors;
(b) an investigation module configured to filter and analyze alerts, the investigation module comprising a ticketing process configured to track alerts;
(c) a reporting module configured to analyze data captured by the information system based on calling patterns.

2. The information system of claim 1 wherein the wireless sensors are assigned to physical locations and organized according to a hierarchy of levels.

3. The information system of claim 1 wherein the reporting module can access information by one or more of the elements in the list consisting of (sensor, duration, frequency, activity, contraband, location).

4. The data processing system of claim 1, wherein the ticketing process comprises three stages including a new stage that occurs at the moment of opening a ticket, an active stage that occurs once a staff member has been assigned to a new ticket and a completed stage that occurs once a staff member has closed the ticket.

5. The data processing system of claim 4 wherein the ticket comprises the following data fields; whether or not a cell phone was found during the search, the location of the phone when found, whether or not the phone was found in the possession of an inmate, the inmate that possessed the phone, the date and time of the confiscation and the barcode or other tracking method attached to the confiscated phone.

6. The information processing system of claim 1, wherein the calling patterns includes specific numbers dialed, calls regularly placed at a specific time or on a specific date, one number being dialed consistently before or after another number is dialed.

7. The information system of claim 1 wherein the reporting module displays connections between entities of interest.

8. The information system of claim 8 wherein the entities of interest are selected from the list comprising (inmate, a telephone call, telephone number, confiscated cell phone, victim, accomplice, street address).

9. The information system of claim 1 wherein the reporting system depicts the physical locations where the highest level of cell phone activity has been recorded over time.

10. A method of monitoring wireless communication activity in an institution using the information system of claim 1, wherein said method comprises the steps of:
(a) assigning wireless sensors to physical locations organized according to a hierarchy of levels;
(b) triggering an alert based on a plurality of wireless sensor detecting a communication signal;
(c) identifying the location of the source of the communication signal based on the signal strength of the plurality of wireless sensors;
(d) notifying security personnel of the alert according to programmable rules;
(e) generating a ticket upon the triggering of an alert.

11. The method of claim 10 wherein the hierarchy comprises levels selected from the list consisting of (agency, facility, building, wing, floor, cell, inmate).

12. The method of claim 11 wherein system security is managed through role-based access control.

13. The method of claim 12 wherein reporting on one or more of the elements in the list consisting of (sensor, duration, frequency, activity, contraband, location).
